(19) United States
(12) Patent Application Publication
(10) Pub. No.: US 2019/0283219 A1
(43) Pub. Date: Sep. 19, 2019

(54) HAND TOOL

(71) Applicant: JUAN M. CASTILLO, Pittsburg, CA (US)

(72) Inventor: JUAN M. CASTILLO, Pittsburg, CA (US)

(21) Appl. No.: 16/431,600

(22) Filed: Jun. 4, 2019

Related U.S. Application Data
(63) Continuation-in-part of application No. 29/635,723, filed on Feb. 1, 2018, now Pat. No. D854897.

(51) Int. Cl. B25B 13/46; B25B 23/16

(52) U.S. Cl. CPC B25B 13/462; B25B 23/0028; B25B 23/16

(57) ABSTRACT

Aspects of the present disclosure generally pertain to a hand tool that combines features of a ratchet and a wrench. Aspects of the present disclosure more specifically are directed toward a ratchet/wrench including at least one additional wrench or spanner integrated in its handle. The hand tool may preferably include wrench sizes most common to a particular task or line of work.

### CROSS-REFERENCE TO RELATED APPLICATION

This application claims the benefit of currently pending U.S. design patent application no. 29/635,723, filed Feb. 1, 2018 entitled “Perforated Ratchet”, which is incorporated by reference herein in its entirety.

### BACKGROUND OF THE INVENTION

### Technical Field

The present disclosure generally pertains to hand tools, and is more particularly directed towards a hand tool that combines features of a ratchet and a wrench.

### Related Art

In the scaffolding industry it is required to carry a full body harness and a tool belt with up to 9 or 10 tools attached to it. This gear weight approximately 30 pounds, and the wearer must carry it during an 8 hour shift every day. Further, having multiple tools may add delay in grabbing the correct tool or dropping one of many. Notwithstanding the current practice to carry multiple, dedicated tools.

U.S. Pat. No. 10,118,278 granted to Thompson, et al. and on Nov. 6, 2018, shows a ratchet wrench including retaining ring. The disclosed ratchet wrench includes a wrench body having a first drive end at a first end of the wrench body, and an aperture in the first drive end that includes a shoulder or retaining web extending into the aperture. A ratchet gear including a receiving portion adapted to engage a work piece for providing torque to the work piece, and a ring groove is disposed in the aperture with the receiving portion and the ring groove on opposite sides of the shoulder. A retaining ring is disposed in the ring groove and adapted to retain the ratchet gear in the aperture. The retaining ring limits offset loading that may be applied to a cover plate and/or retention screws when the tool is being used.

The present disclosure is directed toward overcoming known problems and problems discovered by the inventor. Further, the present disclosure addresses these problem while providing a discrete form of self-defense.

### SUMMARY OF THE DISCLOSURE

Aspects of the present disclosure generally pertain to a hand tool that combines features of a ratchet and a wrench. Aspects of the present disclosure more specifically are directed toward a ratchet/wrench including at least one additional wrench or spanner integrated in its handle.

A hand tool is disclosed herein. The hand tool includes a ratchet head, a wrench head, and a handle, the handle extending between the ratchet head and the wrench head, the handle including a first ring spanner integrated into the handle.

According to one embodiment, the hand tool includes a socket head including a socket drive, a handle extending from the socket head and configured for manually applying torque to the socket head, a wrench head fixed to the handle, opposite the socket head, and a first ring spanner integrated into the handle between the socket head and the wrench head.

### BRIEF DESCRIPTION OF THE DRAWINGS

FIG. 1 is a perspective view of a hand tool, according to an exemplary embodiment of the present disclosure.

FIG. 2 is an alternate perspective view of the hand tool of FIG. 1.

FIG. 3 is a top view of a hand tool, according to an exemplary embodiment of the present disclosure.

FIG. 4 is a front view of the hand tool of FIG. 3.

FIG. 5 is a side view of the hand tool of FIG. 3.

FIG. 6 is a back view of the hand tool of FIG. 3.

FIG. 7 is a bottom view of the hand tool of FIG. 3.

### DETAILED DESCRIPTION

Aspects of the present disclosure generally pertain to a hand tool that combines features of a ratchet and a wrench. Aspects of the present disclosure more specifically are directed toward a ratchet/wrench including at least one additional wrench or spanner integrated in its handle. The hand tool may preferably include wrench sizes most common to a particular task or line of work.

It should be understood that wrench and spanner are used interchangeably herein to refer to a tool used to provide grip and mechanical advantage in applying torque to turn objects—usually rotary fasteners, such as nuts and bolts. These may include both the open variety (open-end wrench and open-ended spanner) and closed variety (box-end wrench and ring spanner).

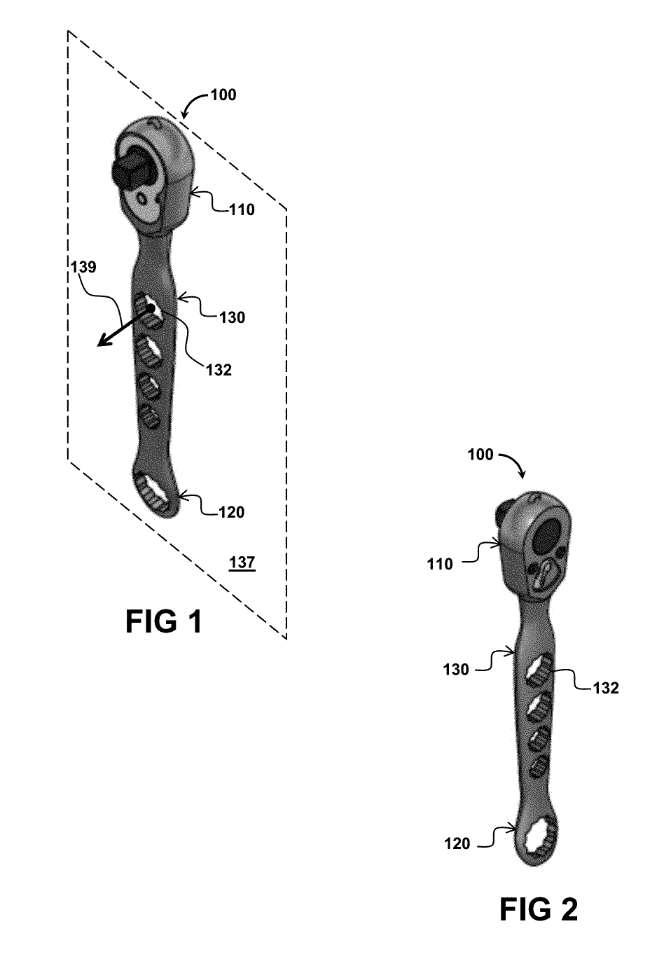

FIG. 1 is a perspective view of a hand tool, according to an exemplary embodiment of the present disclosure. FIG. 2 is an alternate perspective view of the hand tool of FIG. 1. In particular, with reference to FIGS. 1 and 2, a hand tool 100 is shown, and may include a ratchet head 110, a wrench head 120, and a handle 130 extending between the ratchet head and the wrench head, the handle including a first ring spanner 132 integrated into the handle 130.

As illustrated, the wrench head 120 may be arranged as a conventional box-end wrench (or ring spanner) fixed to or otherwise extending from the handle 130. Alternately, the wrench head 120 may be arranged as a conventional open-end wrench or open-ended spanner (not shown). Other wrench types are contemplated (e.g., line/tube wrench, adjustable wrench, etc.). It should be noted that wrench and spanner are used interchangeably throughout.

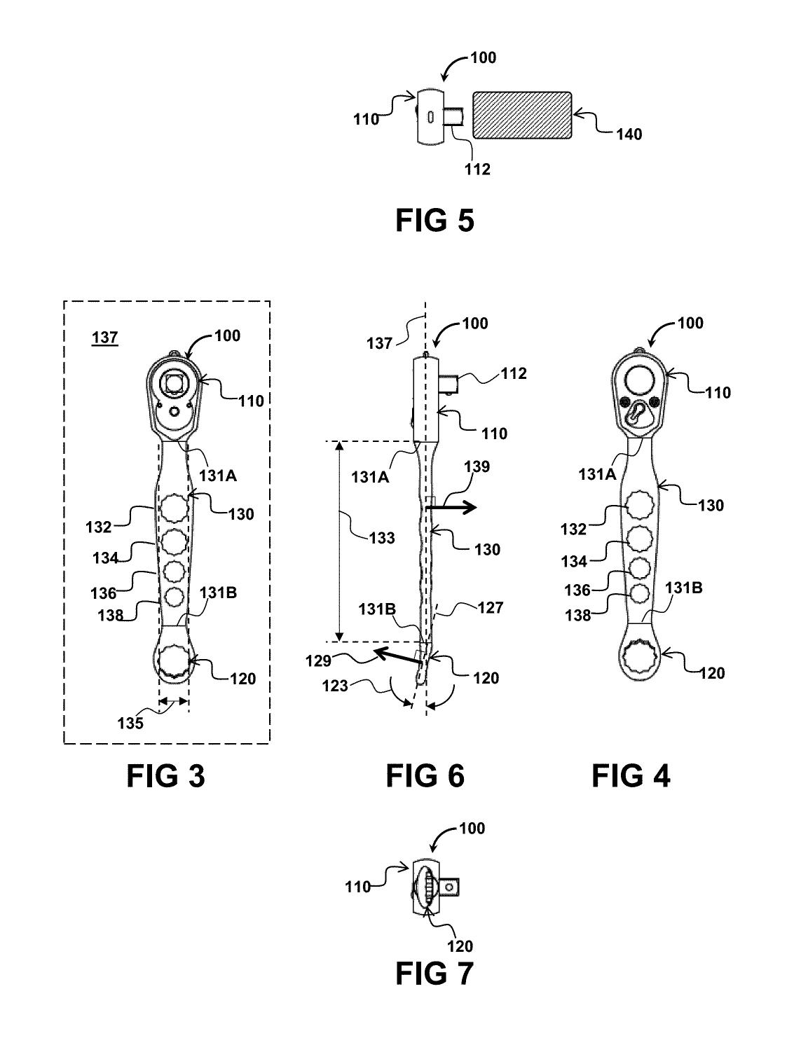

FIG. 3 is a top view of a hand tool, according to an exemplary embodiment of the present disclosure. FIG. 4 is a front view of the hand tool of FIG. 3. FIG. 5 is a side view of the hand tool of FIG. 3. FIG. 6 is a back view of the hand tool of FIG. 3. FIG. 7 is a bottom view of the hand tool of FIG. 3. As above, and with reference to FIGS. 3-7, the hand tool 100 may include the ratchet head 110, the wrench head 120, and the handle 130 with the first ring spanner 132 integrated into the handle 130.

For reference and convenience, the handle 130 may include a first terminal end 131A and a second terminal end 131B opposite the first terminal end 131A. The ratchet head 110 may be fixed to the first terminal end 131A of the handle 130 and the wrench head 120 may be fixed to the second terminal end 131B of the handle 130. Similar to conventional wrenches, the handle 130, the wrench head 120, and portions of the ratchet head 110 may be cast together as a single unit, however any conventional coupling may be employed.

Also for reference and convenience, the handle 130 may have a handle length 133, a handle width 135, and a handle plane 137. The handle length 133 may be generally defined and measured as a longitudinal distance between the first terminal end 131A and the second terminal end 131B. The handle plane 137 may be generally defined as a plane normal to an aperture vector 139 that is normal to the first ring spanner 132, and by the handle length 133. The handle width 135 may be generally defined as an average of handle measurements perpendicular to and along the handle length 133, in the handle plane 137. The abovementioned references should be commonly recognized by one having ordinary skill in the art as being applicable to a standard wrench being generally elongated and flat and having a width and a longitudinal length.

According to one preferred embodiment, the first ring spanner 132 may form an aperture through and circumscribed by the handle 130. Alternately, the first ring spanner 132 may form a recess in the handle 130 without fully perforating the handle 130. Alternately, the first ring spanner 132 may be only partially circumscribed by the handle 132. In each case, the first ring spanner 132 may be positioned between the first terminal end 131A and the second terminal end 131B;

According to one embodiment, the hand tool 100 may further include a socket 140 affixed to the ratchet head 110. For example the socket 140 may be persistently permanently fixed to ratchet head 110. Also for example the socket 140 may be permanently fixed to ratchet head 110. Preferably, the socket 140 will be sized and dimensioned to operate on the same size fastener as the wrench head 120.

According to one preferred embodiment, the ratchet head 110 may include a socket drive 112. In particular, the socket drive 112 may be configured to removably receive the socket 140 and attach it to the ratchet head 110. For example, the socket drive 112 may be a square socket drive found in conventional ratchets, According to a preferred embodiment, the socket drive 112 may be a standard ½ inch square drive.

According to one embodiment, the hand tool 100 may include the ratchet head 110 including the socket drive 112, with the handle 130 extending from the ratchet head 110 and configured for manually applying torque to the ratchet head 110, the wrench head 120 fixed to the handle 130, opposite the socket head, and the first ring spanner 132 integrated into the handle 130 between the ratchet head 110 and the wrench head 120. The hand tool 100 may further include the socket 140, with the socket 140 being configure to removably couple with the socket drive 112 for use in conjunction with the ratchet head 110. Preferably, the socket 140 may be sized and dimensioned to operate on the same size fastener as the wrench head 120, however other sizes of the socket 140 are contemplated. Further, the socket 140 may be interchangeable with a plurality of other sockets, which may be sized and dimensioned differently than the socket 140 and/or for fasteners different from the wrench head 120.

According to one embodiment, the hand tool 100 may be arranged as a kit including a plurality of sockets. For example, the hand tool kit may include the hand tool 100 including the ratchet head 110 with the socket drive 112 (as described above), a first socket 140 configured to removably attach to the socket drive of the ratchet head, and a second socket 140 configured to removably attach to the socket drive of the ratchet head. At least one of the first socket 140 and the second socket 140 may be a deep socket, and further may be sized and dimensioned to operate on a fastener of the same size as the wrench head 120. According to one embodiment, the first socket 140 and the second socket 140 may be each sized and dimensioned to operate on differently sized fasteners.

According to one embodiment, the hand tool 100 may include a plurality of spanners integrated into the handle 130. In particular, the plurality of spanners may integrated into the handle 130 between the ratchet head 110 and the wrench head 120. For example, in addition to the first ring spanner 132, the handle 130 may preferably include a second ring spanner 134, a third ring spanner 136, and a fourth ring spanner 138, where each additional wrench or spanner is integrated into the handle. The first ring spanner 132, the second ring spanner 134, the third ring spanner 136, and the fourth ring spanner 138 may be positioned between the first terminal end 131A and the second terminal end 131B in line with each other. It is be understood than different numbers spanners are contemplated, as well as non-linear positioning of one or more of the integrated spanners.

Preferably, the additional spanners may form an aperture through the handle 130 (e.g., in the direction of aperture vector 139). Alternately, one or more spanners integrated in the handle 130 may only form a recess in the handle 130, without passing through. Also, preferably, the additional spanners may be circumscribed by the handle 130 (i.e. configured as ring spanners or box-wrenches). Further, each of the first, second, third, and four ring spanners 132, 134, 136, 138 may be sized and dimensioned as at least one of six-sided or twelve sided standard wrench Alternately, one or more spanners integrated in the handle 130 may only be partially circumscribed by the handle 130 (i.e. configured as an open-end wrench/open-ended spanner or similar).

According to one preferred embodiment, the first, second, third, and four ring spanners 132, 134, 136, 138 may be sized and dimensioned as one of a ½ inch, a 9/16 inch, an 11/16 inch, and a ¾ inch box wrench integrated into the handle, respectively. No particular order of the first, second, third, and four ring spanners 132, 134, 136, 138 is required, however, in one embodiment, the ring spanner may be positioned or otherwise ordered by size as illustrated (i.e., with the largest proximate the ratchet head 110 and the smallest proximate the wrench head 120). Further, according to one preferred embodiment, the wrench head 120 may be arranged as a ⅞ inch box wrench at the end of the handle. A benefit of this particular arrangement is that it may make scaffold workers more efficient by integrating their most common tools in a single tool. Relatedly, the handle length 133 may be between 9 and 12 inches, and the handle width 135 may be between 1 and 2.5 inches. It is understood that one or more features disclosed herein may alternately be sized according to the metric system rather than standard.

According to embodiments, the hand tool 100 may include one or more ergonomic or performance features. For example, the wrench head 120 may have a wrench plane 127 defined by a torque vector 129 of the wrench head 120 when in use, and the wrench plane 129 may then intersect the handle plane 137 at a wrench angle 123 of between 10 degrees and 45 degrees. Also for example, the handle 130 may have a substantially rectangular perimeter within the handle plane 137 (e.g. as viewed from a front view). Also for example, the handle 130 may have a contoured perimeter between the first terminal end 131A and the second terminal end 131B, within the handle plane.

The above description of the various embodiments is provided to enable a person of ordinary skill in the art to make or use the subject matter of the disclosure. Various modifications to the embodiments will be readily apparent to those skilled in the art, and the generic principles defined herein may be applied to other variations without departing from the spirit or the scope of this disclosure. Thus, it is to be understood that the disclosure is not intended to be limited to the examples and designs described herein, which merely represent a presently preferred implementation of the disclosure, but that the disclosure is to be accorded the widest scope consistent with the principles and novel features disclosed herein. It is to be further understood that the scope of the present disclosure fully encompasses other embodiments that may become obvious to those skilled in the art. For example, the principles of the present disclosure may be applied to other high cost items that are not vehicles but are powered, such as air conditioners for structures, or to more mobile items such as entertainment systems, solar power systems, and the like.

1. A hand tool comprising:
a ratchet head;
a wrench head; and
a handle extending between the ratchet head and the wrench head, the handle including a first ring spanner integrated into the handle.

2. The hand tool of claim 1, wherein the handle includes a first terminal end and a second terminal end opposite the first terminal end, the first ring spanner forming an aperture through and circumscribed by the handle, the first ring spanner positioned between the first terminal end and the second terminal end;
wherein the ratchet head includes a socket drive, the ratchet head fixed to the first terminal end of the handle; and
wherein the wrench head is arranged as a box-end wrench, the wrench head fixed to the second terminal end of the handle.

3. The hand tool of claim 2, further comprising a socket configured to removably attach to the socket drive of the ratchet head.

4. The hand tool of claim 3, wherein the handle further includes a second ring spanner, a third ring spanner, and a fourth ring spanner each integrated into the handle, forming an additional aperture through and circumscribed by the handle; and
wherein the first ring spanner, the second ring spanner, the third ring spanner, and the fourth ring spanner are positioned between the first terminal end and the second terminal end in line with each other.

5. The hand tool of claim 4, wherein the socket drive of the ratchet head is a ½ inch square drive;
wherein the wrench head is further arranged as a ⅞ inch box wrench at the end of the handle; and
wherein the first, second, third, and four ring spanners are a ½ inch, a 9/16 inch, an 11/16 inch, and a ¾ inch box wrenches integrated into the handle, respectively.

6. The hand tool of claim 4, wherein the first, second, third, and four ring spanners are at least one of six-sided or twelve sided standard wrench.

7. The hand tool of claim 2, wherein the handle includes a second ring spanner, integrated into the handle, forming an aperture through and circumscribed by the handle; and
wherein the first ring spanner and the second ring spanner are positioned between the first terminal end and the second terminal end in line with each other.

8. The hand tool of claim 2, wherein the handle has a handle length, a handle width, and a handle plane, the handle length generally defined and measured as a longitudinal distance between the first terminal end and the second terminal end, the handle plane generally defined as a plane normal to a vector normal to the aperture of the first ring spanner, and by the handle length, the handle width generally defined as an average of measurements perpendicular to and along the handle length, in the handle plane.

9. The hand tool of claim 8, wherein the handle length is between 24 and 34 cm, and the handle width is between 3 and 6 cm.

10. The hand tool of claim 8, wherein the wrench head has a wrench plane defined by a torque vector of the wrench head when in use; and
wherein the wrench plane intersects the handle plane at a wrench angle of between 10 degrees and 45 degrees.

11. The hand tool of claim 8, wherein the handle has a substantially rectangular perimeter within the handle plane.

12. The hand tool of claim 8, wherein the handle has a contoured perimeter between the first terminal end and the second terminal end, within the handle plane.

13. The hand tool of claim 1, further comprising a socket fixed to the ratchet head.

14. The hand tool of claim 1, wherein the wrench head is arranged as an open-end wrench.

15. A hand tool comprising
a ratchet head including a socket drive;
a handle extending from the ratchet head and configured for manually applying torque to the ratchet head;
a wrench head fixed to the handle, opposite the ratchet head; and
a first ring spanner integrated into the handle between the socket head and the wrench head.

16. The hand tool of claim 15, further comprising:
a second ring spanner integrated into the handle between the socket head and the wrench head;
a third ring spanner integrated into the handle between the socket head and the wrench head; and
a fourth ring spanner integrated into the handle between the socket head and the wrench head;

17. The hand tool of claim 16, wherein the first ring spanner, the second ring spanner, the third ring spanner, and the fourth ring spanner are linearly distributed between the socket head and the wrench head.

18. A hand tool kit comprising:
a hand tool including a ratchet head including a socket drive, a handle extending from the ratchet head and configured for manually applying torque to the ratchet head, a wrench head fixed to the handle, opposite the ratchet head, and a first ring spanner integrated into the handle between the socket head and the wrench head;
a first socket configured to removably attach to the socket drive of the ratchet head; and
a second socket configured to removably attach to the socket drive of the ratchet head.

19. The hand tool of claim 18, wherein the first socket is a deep socket, sized and dimensioned to operate on a fastener of the same size as the wrench head.

20. The hand tool of claim 18, wherein the first socket and the second socket are each sized and dimensioned to operate on differently sized fasteners.
